(19) United States
(12) Patent Application Publication
(10) Pub. No.: US 2025/0140775 A1
(43) Pub. Date: May 1, 2025

(54) METHOD FOR INCREASING MECHANICAL STRENGTH OF LITHIUM METAL AND 3D ANODE CURRENT COLLECTOR OF ANODE ELECTRODE

(71) Applicant: GM GLOBAL TECHNOLOGY OPERATIONS LLC, Detroit, MI (US)

(72) Inventors: Sayed Youssef Sayed NAGY, Troy, MI (US); Diptak BHATTACHARYA, Royal Oak, MI (US); Caleb REESE, Ferndale, MI (US); Anil K. SACHDEV, Rochester Hills, MI (US)

(21) Appl. No.: 18/494,203

(22) Filed: Oct. 25, 2023

(51) Int. Cl. H01M 4/04; H01M 4/02; H01M 4/1395; H01M 4/36; H01M 4/38; H01M 4/48; H01M 4/66; H01M 4/74

(52) U.S. Cl. CPC H01M 4/0404; H01M 4/0435; H01M 4/0452; H01M 4/0471; H01M 4/0483; H01M 4/1395; H01M 4/366; H01M 4/382; H01M 4/483; H01M 4/661; H01M 4/74; H01M 2004/021; H01M 2004/027

(57) ABSTRACT

A method for manufacturing a battery cell includes coating a three dimensional current collector (3DCC) with a lithiophilic metal oxide layer; and one of laminating the 3DCC with the lithiophilic metal oxide layer between a first lithium metal layer and a second lithium metal layer to create an anode electrode; and coating the 3DCC with the lithiophilic metal oxide layer with molten lithium to create an anode electrode.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to anode electrodes including lithium metal and 3D current collectors.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A method for manufacturing a battery cell includes coating a three dimensional current collector (3DCC) with a lithiophilic metal oxide layer; and one of laminating the 3DCC with the lithiophilic metal oxide layer between a first lithium metal layer and a second lithium metal layer to create an anode electrode; and coating the 3DCC with the lithiophilic metal oxide layer with molten lithium to create an anode electrode.

In other features, the 3DCC comprises copper mesh. The lithiophilic metal oxide layer is formed on the 3DCC using electrochemical deposition. The lithiophilic metal oxide layer includes a material selected from a group consisting of zinc oxide (ZnO), indium oxide (In₂O₃), tin oxide (SnO₂), bismuth oxide (Bi₂O₃), and aluminum oxide (Al₂O₃). The laminating includes pressing the first lithium metal layer, the 3DCC with the lithiophilic metal oxide layer, and the second lithium metal layer between a pair of rollers. The first lithium metal layer, the 3DCC with the lithiophilic metal oxide layer, and the second lithium metal layer are heated during pressing between the pair of rollers to a temperature in a range from 25° C. to 180° C.

In other features, the 3DCC is coated with the molten lithium, wherein the molten lithium is heated to a temperature in a range from 250° C. to 350° C. The lithiophilic metal oxide layer has a thickness in a range from 20 nm to 200 nm. The lithiophilic metal oxide layer has a thickness in a range from 75 nm to 125 nm.

In other features, the method includes arranging A of the anode electrode, C cathode electrodes, and S separators in a battery stack, where A, C, and S are integers greater than one.

A method for manufacturing a battery cell comprises coating a copper mesh with a lithiophilic metal oxide layer selected from a group consisting of zinc oxide (ZnO), indium oxide (In₂O₃), tin oxide (SnO₂), bismuth oxide (Bi₂O₃), and aluminum oxide (Al₂O₃); and laminating the copper mesh with the lithiophilic metal oxide layer between a first lithium metal layer and a second lithium metal layer to create an anode electrode.

In other features, the lithiophilic metal oxide layer is formed on the copper mesh using electrochemical deposition. The first lithium metal layer, the copper mesh with the lithiophilic metal oxide layer, and the second lithium metal layer are heated during pressing between a pair of rollers to a temperature in a range from 25° C. to 180° C. The lithiophilic metal oxide layer has a thickness in a range from 75 nm to 125 nm.

In other features, the method includes arranging A of the anode electrode, C cathode electrodes, and S separators in a battery stack, where A, C, and S are integers greater than one.

A method for manufacturing a battery cell includes coating a copper mesh with a lithiophilic metal oxide layer selected from a group consisting of zinc oxide (ZnO), indium oxide (In₂O₃), tin oxide (SnO₂), bismuth oxide (Bi₂O₃), and aluminum oxide (Al₂O₃); and coating the copper mesh with the lithiophilic metal oxide layer with molten lithium to create an anode electrode.

In other features, the lithiophilic metal oxide layer is formed on the copper mesh using electrochemical deposition. The copper mesh is coated with the molten lithium, wherein the molten lithium is heated to a temperature in a range from 250° C. to 350° C. The lithiophilic metal oxide layer has a thickness in a range from 75 nm to 125 nm. The method includes arranging A of the anode electrode, C cathode electrodes, and S separators in a battery stack, where A, C, and S are integers greater than one.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell according to the present disclosure;

FIG. 2 is a perspective view of an anode current collector according to the present disclosure;

FIG. 3 is a side cross sectional view of an anode electrode according to the present disclosure;

FIG. 4 illustrates coating of an anode current collector with a lithiophilic metal oxide according to the present disclosure;

FIG. 5 illustrates coating of the anode current collector with the lithiophilic metal oxide coating using molten lithium according to the present disclosure;

FIG. 6 illustrates lamination of the lithium metal around the anode current collector with the lithiophilic metal oxide coating according to the present disclosure;

FIG. 7 illustrates engineering stress as a function of engineering strain for anode electrodes with and without the lithiophilic metal oxide coating according to the present disclosure;

FIGS. 8 and 9 illustrates engineering stress as a function of engineering strain for lithium and anode electrodes with and without the lithiophilic metal oxide coating according to the present disclosure;

FIGS. 10A and 10B are scanning electron microscope images of an anode electrode without a lithiophilic metal oxide coating; and

FIGS. 11A and 11B are scanning electron microscope images of an anode electrode without a lithiophilic metal oxide coating according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

Some anode electrodes include lithium metal as the active material layer and a three-dimensional current collector (3DCC) made of copper due to the low resistance of copper. The anode electrodes are fabricated by embedding the three-dimensional current collector (3DCC) in the lithium metal. For example, a roll-to-roll manufacturing process can be used to laminate the lithium around the 3DCC or the 3DCC can be immersed in molten lithium. However, voids may exist around the anode electrode after manufacturing since the lithium is mechanically but not chemically bonded to the 3DCC. The interaction between the 3DCC and the lithium is mechanical and the composite anode electrode is prone to deformation and fracture, which limits processing speed and handleability.

The strength of the anode electrode is important to prevent delamination, damage, and/or tearing during handling in a roll-to-roll manufacturing process and during battery operation. The strength of the anode electrode can be increased using stronger wire mesh and/or allying of the lithium metal layer. In some manufacturing processes, stronger wire mesh is used.

Stronger wire mesh typically increases the weight of the anode electrode and/or the resistance. For example, Cu300 (e.g., 300 openings per square inch and 35 μm wire) is stronger and heavier than Cu100 (e.g., 100 openings per square inch and 30 μm wire). SS100 (e.g., 100 openings per square inch and 30 μm wire) is stronger than either Cu100 or Cu300 but is heavier and has higher resistance than Cu100. Higher resistance causes higher heating of the battery cell during cycling. In some manufacturing processes, the lithium is alloyed with another metal such as magnesium, zinc, silver, and/or tin to enhance strength. Alloying of the lithium reduces anode capacity and/or makes the anode electrode heavier.

The method for manufacturing the anode electrode according to the present disclosure increases the mechanical strength of the lithium metal anode electrode by using a thin lithiophilic metal oxide coating layer on the 3DCC without increasing the weight of the anode electrode. For example, the metal oxide coating can include zinc oxide (ZnO), indium oxide (In₂O₃), tin oxide (SnO₂), bismuth oxide (Bi₂O₃), aluminum oxide (Al₂O₃), or other suitable lithiophilic metal oxide. The lithium metal is embedded into the metal oxide-coated 3DCC to form a strong and stiff composite anode electrode. In some examples, the lithium-copper composite anode electrode fabricated using lithiophilic metal oxide coated 3DCC is 2× stiffer and 4× stronger compared with anode counterparts made without a coating on the 3DCC. The lithium metal makes a bond with the lithiophilic metal oxide layer to provide additional stiffness and strength.

Referring now to FIG. 1, a battery cell 10 includes C cathode electrodes 20, A anode electrodes 40, and S separators 32 arranged in a predetermined sequence in a battery cell stack 12. The battery cell stack 12 is located in an enclosure 50 that includes an electrolyte, where C, S and A are integers greater than zero. The C cathode electrodes 20-1, 20-2, . . . , and 20-C include cathode active material layers 24 arranged on one or both sides of a cathode current collector 26.

In some examples, the A anode electrodes 40 and the C cathode electrodes 20 exchange lithium ions during charging and discharging. The A anode electrodes 40-1, 40-2, . . . , and 40-A include anode active material layers 42 arranged on one or both sides of the anode current collectors 46. In some examples, the cathode active material layers 24 comprise coatings including one or more active materials, one or more conductive additives, and/or one or more binder materials that are applied to the current collectors.

In some examples, the cathode current collector 26 and the anode current collectors 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or opposite sides of the battery cell stack 12. The external tabs 28 and 48 are connected to terminals of the battery cells.

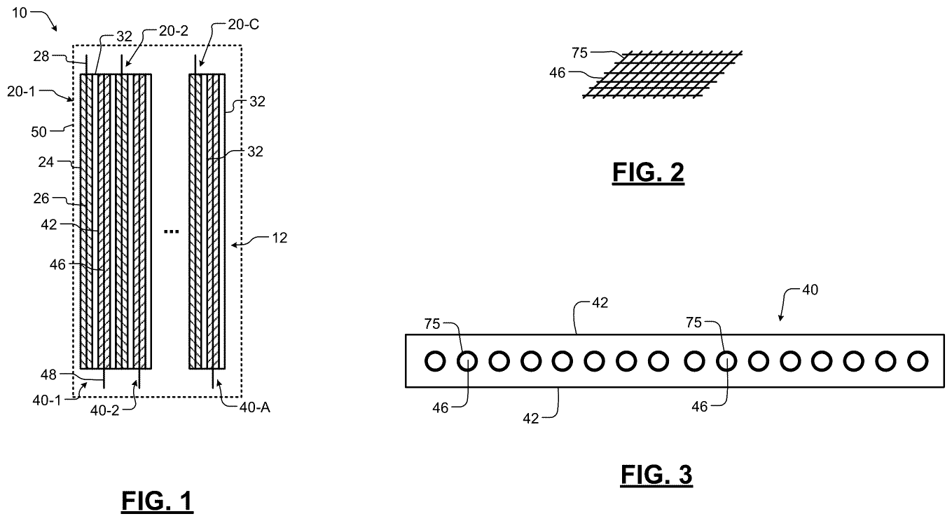

Referring now to FIGS. 2 and 3, an anode current collector and an anode electrode are shown, respectively. In FIG. 2, the anode current collector 46 is coated with a lithiophilic metal oxide layer 75. In FIG. 3, the anode electrode 40 includes the anode current collector 46 with the lithiophilic metal oxide layer 75. In some examples, the lithiophilic metal oxide layer 75 has a thickness in a range from 20 nm to 200 nm. In some examples, the lithiophilic metal oxide layer 75 has a thickness in a range from 75 nm to 125 nm (e.g., 100 nm).

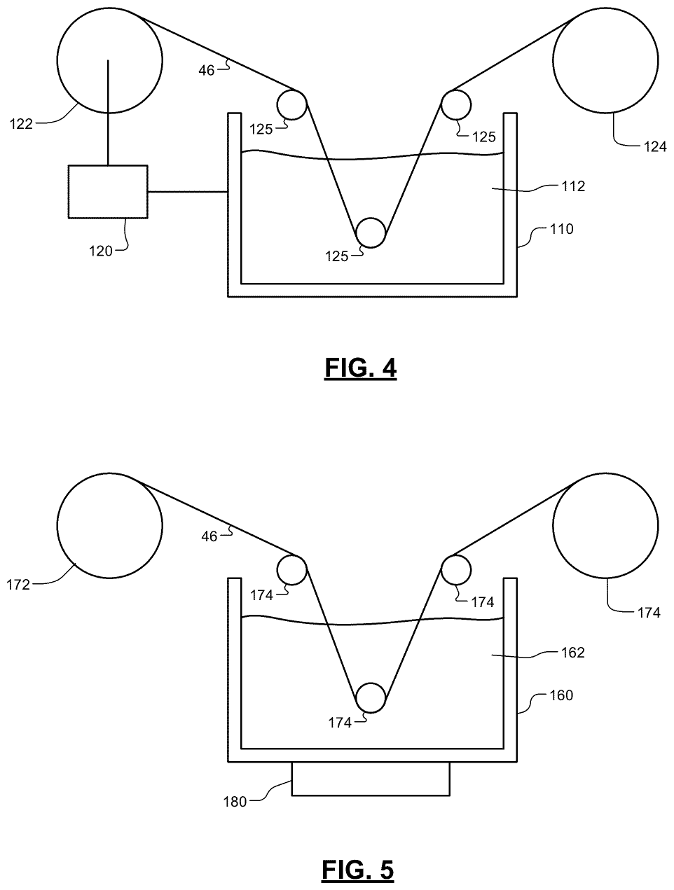

Referring now to FIG. 4, a method for coating the anode current collector 46 with the lithiophilic metal oxide layer 75 is shown. A roll 122 supplies a discrete or continuous anode current collector 46 to a tank 110 including a metal salt of a lithiophilic metal oxide. A power supply 120 creates a potential difference between the anode current collector and the tank 110 to facilitate electrochemical deposition. Additional rollers 125 can be used to direct the anode current collector 46 into and out of the tank 110. The anode current collector 46 can be loaded onto a roll 124 after coating.

Referring now to FIG. 5, coating of the anode current collector 46 with the lithiophilic metal oxide coating 75 with molten lithium is shown. A roll 172 supplies a discrete or continuous anode current collector 46 with the lithiophilic metal oxide coating 75 into a tank 160 including molten lithium metal. The tank 160 is heated by a heater 180 to a temperature in a range from 250° C. to 350° C. Additional rollers 175 can be used to direct the anode current collector 46 with the lithiophilic metal oxide coating 75 through the tank 160. The anode current collector 46 with the lithiophilic metal oxide coating 75 can be loaded onto a roll 174 after coating with the molten lithium.

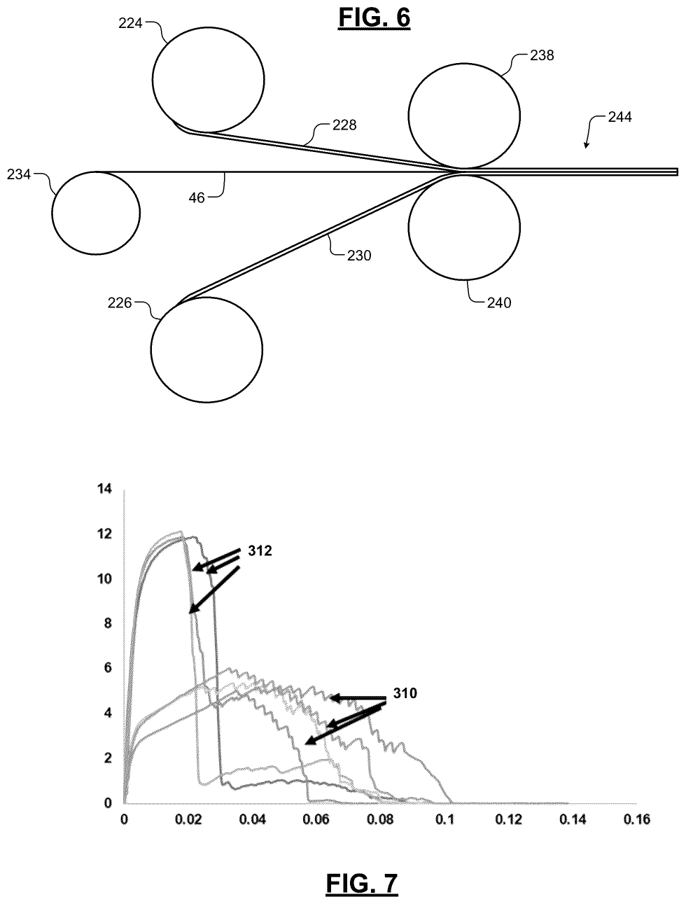

Referring now to FIG. 6, since lithium metal is extremely soft, first and second lithium metal layers can also be laminated from opposite sides of the anode current collector with the lithiophilic metal oxide coating. The mechanical pressure (and optionally heat) can be used to join a seam between the first and second lithium metal layers. Rollers 224 and 226 supply lithium metal layers 228 and 230 such as lithium foil between rollers 238 and 240, respectively. A roller 234 supplies an anode current collector 46 with the lithiophilic metal oxide layer 75 between the lithium metal layers 228 and 230. The rollers 238 and 240 press (and optionally heat) the lithium metal layer 228, the anode current collector 236 and the lithium metal layer 230 to form a composite anode electrode. Because the lithium metal layers 228 and 230 are soft, the anode current collector 236 is pressed into or embedded in abutting surfaces of the lithium metal layers 228 and 230. In some examples, the rollers 228 and 230 are heated to a temperature in a range from 25° C. to 180° C.

Referring now to FIG. 7, engineering stress is shown as a function of engineering strain for anode electrodes with the lithiophilic metal oxide coating (at 312) and without the lithiophilic metal oxide coating (at 310). As can be seen in FIG. 7, the anode electrodes with the lithiophilic metal oxide coating on the current collector an withstand higher stress.

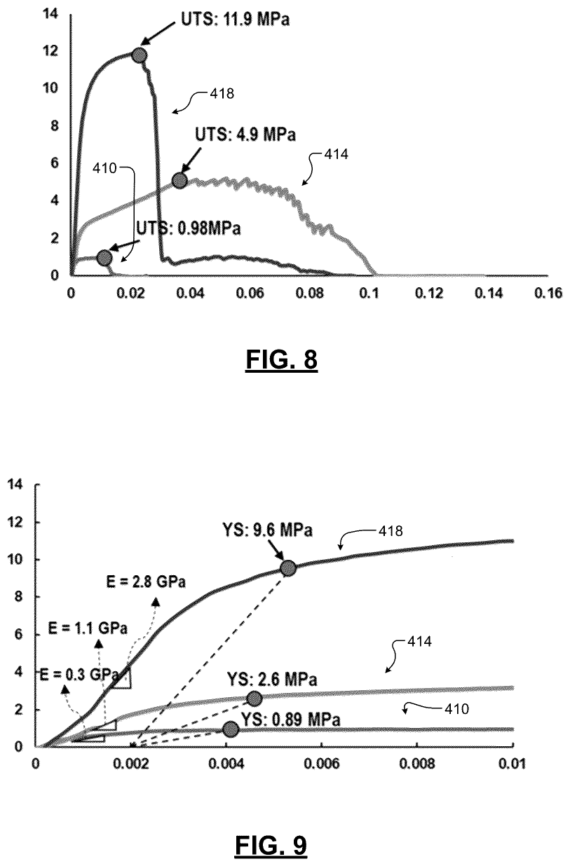

Referring now to FIGS. 8 and 9, engineering stress is shown as a function of engineering strain for lithium (at 410) and anode electrodes with the lithiophilic metal oxide coating at 418 and without the lithiophilic metal oxide coating at 414. Yield strength (YS) is the stress level at which the relationship between stress and strain is no longer linear, E corresponds to Young's modulus, and UTS corresponds to ultimate tensile strength.

As can be seen, the anode electrode with the lithiophilic metal oxide coating (e.g., ZnO) is stiffer by ˜2.58× and stronger by ˜3× to 4× the stiffness and strength of the anode electrode without the metal oxide coating. Additional parameters of the materials are shown in the Table below:

| | Elastic | | |
|---|---|---|---|
| | Modulus | Yield Stress | Max Stress |
| Material | (GPa) | (MPa) | (MPa) |
| Pure Li | 0.3 | 0.89 | 0.98 |
| Bare Cu100 | 3.3 | 126 | 180 |
| ZnO coated Cu100 | 3.3 | 142 | 170 |
| Li + Cu100 | 1.1 | 2.6 | 4.9 |
| Li + ZnO coated | 2.8 | 9.6 | 11.9 |
| Cu100 | | | |

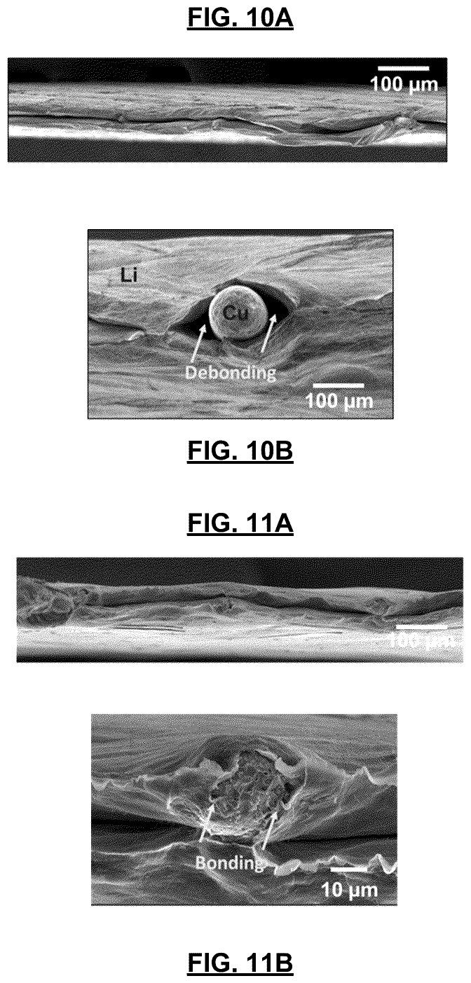

Referring now to FIGS. 10A to 11B, scanning electron microscope images of examples of the anode electrode are shown. In FIGS. 10A and 10B, the anode current collector is not coated with the lithiophilic metal oxide. Voids are created due to tensile deformation and debonding occurs. In FIGS. 11A and 11B, the anode current collector is coated with the lithiophilic metal oxide. The lithiophilic metal oxide creates a stronger interface between the lithium metal and the anode current collector and there are reduced instances of voids/delamination at the lithium/copper interface due to the lithiophilic coating at the interface.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a battery cell, comprising:
coating a three dimensional current collector (3DCC) with a lithiophilic metal oxide layer; and
one of:
laminating the 3DCC with the lithiophilic metal oxide layer between a first lithium metal layer and a second lithium metal layer to create an anode electrode; and
coating the 3DCC with the lithiophilic metal oxide layer with molten lithium to create an anode electrode.

2. The method of claim 1, wherein the 3DCC comprises copper mesh.

3. The method of claim 1, wherein the lithiophilic metal oxide layer is formed on the 3DCC using electrochemical deposition.

4. The method of claim 3, wherein the lithiophilic metal oxide layer includes a material selected from a group consisting of zinc oxide (ZnO), indium oxide (In2O3), tin oxide (SnO₂), bismuth oxide (Bi₂O₃), and aluminum oxide (Al₂O₃).

5. The method of claim 3, wherein the laminating includes pressing the first lithium metal layer, the 3DCC with the lithiophilic metal oxide layer, and the second lithium metal layer between a pair of rollers.

6. The method of claim 5, wherein the first lithium metal layer, the 3DCC with the lithiophilic metal oxide layer, and the second lithium metal layer are heated during pressing between the pair of rollers to a temperature in a range from 25° C. to 180° C.

7. The method of claim 3, wherein the 3DCC is coated with the molten lithium, wherein the molten lithium is heated to a temperature in a range from 250° C. to 350° C.

8. The method of claim 1, wherein the lithiophilic metal oxide layer has a thickness in a range from 20 nm to 200 nm.

9. The method of claim 1, wherein the lithiophilic metal oxide layer has a thickness in a range from 75 nm to 125 nm.

10. The method of claim 1, further comprising arranging A of the anode electrode, C cathode electrodes, and S separators in a battery stack, where A, C, and S are integers greater than one.

11. A method for manufacturing a battery cell, comprising:
coating a copper mesh with a lithiophilic metal oxide layer selected from a group consisting of zinc oxide (ZnO), indium oxide (In₂O₃), tin oxide (SnO₂), bismuth oxide (Bi₂O₃), and aluminum oxide (Al₂O₃); and
laminating the copper mesh with the lithiophilic metal oxide layer between a first lithium metal layer and a second lithium metal layer to create an anode electrode.

12. The method of claim 11, wherein the lithiophilic metal oxide layer is formed on the copper mesh using electrochemical deposition.

13. The method of claim 11, wherein the first lithium metal layer, the copper mesh with the lithiophilic metal oxide layer, and the second lithium metal layer are heated during pressing between a pair of rollers to a temperature in a range from 25° C. to 180° C.

14. The method of claim 11, wherein the lithiophilic metal oxide layer has a thickness in a range from 75 nm to 125 nm.

15. The method of claim 11, further comprising arranging A of the anode electrode, C cathode electrodes, and S separators in a battery stack, where A, C, and S are integers greater than one.

16. A method for manufacturing a battery cell, comprising:
coating a copper mesh with a lithiophilic metal oxide layer selected from a group consisting of zinc oxide (ZnO), indium oxide (In₂O₃), tin oxide (SnO₂), bismuth oxide (Bi₂O₃), and aluminum oxide (Al₂O₃); and
coating the copper mesh with the lithiophilic metal oxide layer with molten lithium to create an anode electrode.

17. The method of claim 16, wherein the lithiophilic metal oxide layer is formed on the copper mesh using electrochemical deposition.

18. The method of claim 16, wherein the copper mesh is coated with the molten lithium, wherein the molten lithium is heated to a temperature in a range from 250° C. to 350° C.

19. The method of claim 16, wherein the lithiophilic metal oxide layer has a thickness in a range from 75 nm to 125 nm.

20. The method of claim 16, further comprising arranging A of the anode electrode, C cathode electrodes, and S separators in a battery stack, where A, C, and S are integers greater than one.
